(19) United States
(12) Patent Application Publication
(10) Pub. No.: US 2024/0167419 A1
(43) Pub. Date: May 23, 2024

(54) PROCESS FOR USING WASTE HEAT FROM THE UTILIZATION OF LOW, NEUTRAL AND/OR NEGATIVE CARBON INTENSITY HYDROGEN

(71) Applicant: Kraken Technology Holdings, LLC, Houston, TX (US)

(72) Inventors: Christopher Michael MILLER, Richmond, TX (US); Anna Louise BUCKLEY, Houston, TX (US); Byron Gladus BEST, III, Katy, TX (US); Bengt Arne JARLSJO, Houston, TX (US); Daniel Joseph SHAPIRO, Houston, TX (US)

(21) Appl. No.: 18/472,809

(22) Filed: Sep. 22, 2023

Related U.S. Application Data
(63) Continuation-in-part of application No. 18/117,606, filed on Mar. 6, 2023, now Pat. No. 11,952,276.
Application No. 18/117,606 is a continuation-in-part of application No. 18/325,624, filed on May 30, 2023.
Application No. 18/325,624 is a continuation-in-part of application No. 18/471,768, filed on Sep. 21, 2023.
(60) Provisional application No. 63/451,940, filed on Mar. 14, 2023.
(60) Provisional application No. 63/482,430, filed on Jan. 31, 2023.
(60) Provisional application No. 63/427,258, filed on Nov. 22, 2022.

(51) Int. Cl. F02C 6/18; F02C 3/22; F02C 7/22

(52) U.S. Cl. CPC F02C 6/18; F02C 3/22; F02C 7/22

(57) ABSTRACT

Methods for the beneficial use of waste heat in commercial or industrial operations are provided. The method includes generating power by combusting hydrogen in a gas turbine or through an electrochemical process using hydrogen in a fuel cell, recovering waste heat from the gas turbine exhaust in a heat recovery steam generator, and utilizing the waste heat in one or more commercial or industrial operations. The hydrogen has a carbon intensity preferably less than about 1.0 kg CO₂e/kg H₂ and may be produced by reforming a hydrocarbon feedstock or by electrolysis of water, wherein at least some of the required energy for the hydrogen production process is provided by a biomass power plant with carbon capture.

### CROSS-REFERENCE TO RELATED APPLICATION

This application claims the benefit of U.S. Prov. App. Nos. 63/451,940 (filed Mar. 14, 2023); 63/482,430 (filed Jan. 31, 2023), and 63/427,258 (filed Nov. 22, 2022); and is a continuation-in-part of U.S. application Ser. No. 18/117,606 (filed Mar. 6, 2023), Ser. No. 18/325,624 (filed May 30, 2023), and Ser. No. 18/471,768 (filed Sep. 21, 2023); all of which are incorporated by reference herein in their entireties.

### BACKGROUND

The present invention relates to the beneficial use of waste heat produced from the utilization of low, neutral and/or negative carbon intensity hydrogen.

Many industrial applications that generate waste heat use either cooling water or air-cooled heat exchangers to cool process fluids. In these applications, the heat generated by the system is rejected to the atmosphere by evaporative cooling towers or fans. This waste heat could be captured for beneficial use to optimize the heat integration of the facility and/or for external beneficial purposes.

As the global economy drives towards environmental, social, and governance (ESG) solutions for industrial facilities, waste heat must be captured and utilized for beneficial use.

Low, neutral, and/or negative carbon intensity hydrogen may be produced through reforming a hydrocarbon feedstock with biomass energy, as is described in co-owned U.S. application Ser. No. 18/117,606, or through electrolysis with biomass energy, as is described in co-owned U.S. Prov. App. No. 63/451,940, and can be used in multiple applications that generate waste heat that can be harnessed and repurposed for beneficial uses including heat integration with industrial processes, including greenhouses.

Greenhouses provide a sheltered, artificial environment to facilitate the growth of plants in a non-ideal climate. Even in temperate climates, greenhouses require artificial heating to maintain temperatures above freezing and provide an optimal temperature for plant growth. Most of the heat is lost from conduction of the heat from the warm greenhouse interior through the greenhouse glazing to the colder exterior. Heat can also be lost from infiltration of cold air through cracks or holes in the exterior of the greenhouse, including doors and ventilation systems. Radiation, the transfer of heat from a warm greenhouse to a colder exterior environment without direct contact, can also lead to greenhouse heat loss.

To overcome heat loss to the environment and maintain an ideal temperature, greenhouses are equipped with central and/or local heating systems. Typically, central heating systems consist of a boiler and a distribution system that supplies thermal energy, as either hot water and/or steam, to the greenhouse. Local heating systems, either vented or unvented unit heaters, transfer heat through the combustion of hydrocarbon gases to provide heating to the greenhouse.

The present invention provides a method and process for the beneficial use of waste heat produced from the utilization of low, neutral and/or negative carbon intensity hydrogen.

Both the central and local heating systems provide a source of thermal energy for greenhouse heating. The utilization of low, neutral, and/or negative carbon intensity hydrogen to produce carbon neutral or carbon negative electricity through combustion in a gas turbine or through an electrochemical process in a fuel cell generates waste heat that can be repurposed for beneficial uses. The waste heat can be utilized to provide thermal energy, in the form of hot water and/or steam to nearby greenhouses instead of a dedicated central or local heating system to maintain temperatures above freezing and provide an optimal temperature for plant growth.

The carbon neutral or carbon negative electricity produced through the utilization of low, neutral, and/or negative carbon intensity hydrogen can also be used to provide power to the greenhouse directly. Carbon neutral or carbon negative electricity can be used to power growth lights, which are designed to stimulate photosynthesis and prolong exposure in the absence of natural sunlight, enhancing plant growth.

### SUMMARY OF THE INVENTION

Methods for the beneficial use of waste heat in commercial or industrial operations is provided. The methods include generating power by combusting hydrogen in a gas turbine or through an electrochemical process using hydrogen in a fuel cell, recovering waste heat from the gas turbine exhaust in a heat recovery steam generator, and utilizing the waste heat in one or more commercial or industrial operations.

The hydrogen has a carbon intensity preferably less than about 1.0 kg CO₂e/kg H₂, more probably less than about 0.45 kg CO₂e/kg H₂, and most preferably less than about 0.0 kg CO₂e/kg H₂. The hydrogen may be produced by reforming a hydrocarbon feedstock, wherein at least some of the required energy for the reforming process is provided by a biomass power plant with carbon capture. The hydrogen may also be produced by electrolysis of water, wherein at least some of the required energy for the electrolysis process is provided by a biomass power plant with carbon capture.

The waste heat may be converted to hot water or steam that can be used as thermal energy in the one or more commercial or industrial operations. At least some of the waste heat may be used as thermal energy in an absorption chiller to provide cooling duty for the one or more commercial or industrial operations. At least some of the waste heat may be converted to steam used to power a mechanical drive for one or more motors generating shaft torque in the commercial or industrial operations.

The commercial or industrial operations may include one or more greenhouses, one or more algae farms, and/or one or more data centers. Thermal energy from the waste heat may be used to heat one or more greenhouses, one or more algae farms, and/or one or more data centers. Thermal energy from the waste heat may also be used to cool one or more data centers.

### DESCRIPTION OF FIGURES

The features and advantages of the present invention will be more clearly understood from the following description taken in conjunction with the accompanying drawings in which:

FIG. 1 depicts a process flow diagram in which electricity for a data center and a greenhouse is produced using low, neutral and/or negative carbon intensity hydrogen as fuel for a combined cycle turbine.

FIG. 2 depicts a process flow diagram in which electricity for a data center and a greenhouse is produced using low, neutral and/or negative carbon intensity hydrogen as fuel for a fuel cell.

### DETAILED DESCRIPTION OF THE INVENTION

The present invention relates to a method and process for the beneficial use of waste heat produced from the utilization of low, neutral and/or negative carbon intensity hydrogen.

In all embodiments of the present invention described herein, the low, neutral, and/or negative carbon intensity hydrogen may be produced according to the teachings of commonly owned U.S. application Ser. No. 18/117,606 (filed Mar. 6, 2023), which is incorporated by reference herein in its entirety. As discussed therein, the energy for the hydrogen production process is provided by the combustion or gasification of various forms of biomass to reduce the carbon intensity of the hydrogen product to preferably less than about 1.0 kg CO₂e/kg H₂, more preferably less than about 0.45 kg CO₂e/kg H₂, and most preferably less than about 0.0 kg CO₂e/kg H₂.

In all embodiments of the present invention described herein, the low, neutral, and/or negative carbon intensity hydrogen may be produced according to the teachings of commonly owned U.S. Prov. App. Nos. 63/451,940 (filed Mar. 14, 2023), which is incorporated by reference herein in its entirety. As discussed therein, the energy to produce hydrogen through electrolysis is provided by an integrated biomass energy plus carbon capture to reduce the carbon intensity of the hydrogen product to preferably less than about 0.45 kg CO₂e/kg H₂ and more preferably less than about 0.0 kg CO₂e/kg H₂.

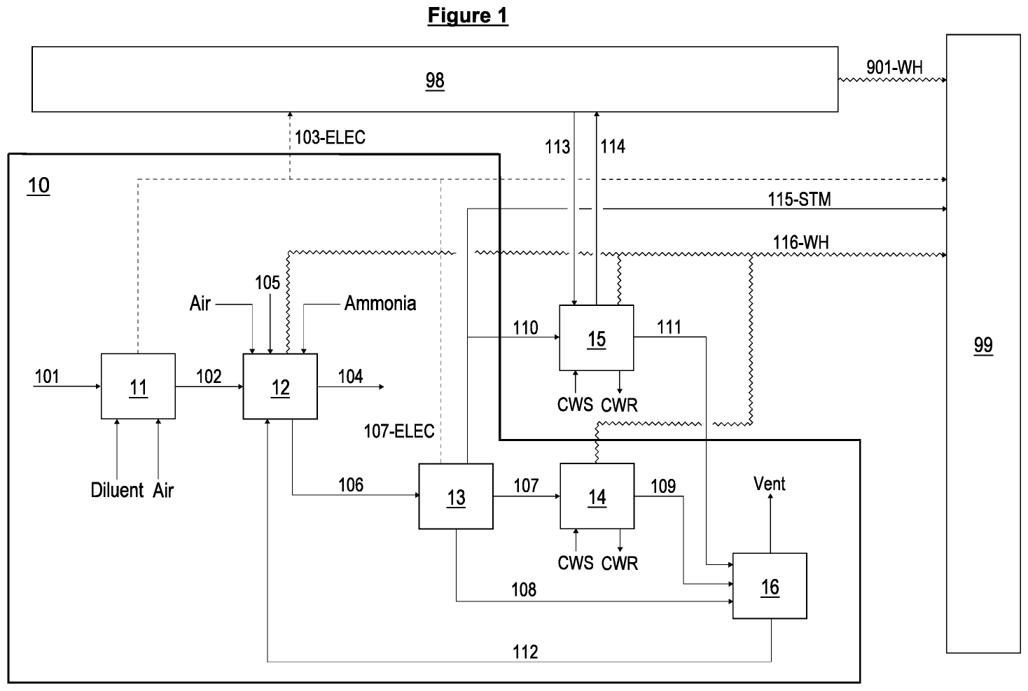

With reference to FIG. 1, a first embodiment of the present invention is depicted, in which waste heat from combined cycle gas turbine 10 is used as a source of thermal energy to provide heating to greenhouse 99. In all embodiments, the waste heat can also be utilized as a source of thermal heat to provide heating for a variety of commercial and/or industrial applications, including, but not limited to algae farms, district heating, office buildings, and/or warehouses. For illustrative purposes only, the commercial and/or industrial application is represented by greenhouse 99.

The combined cycle gas turbine 10 utilizes low, neutral and/or negative carbon intensity hydrogen as a fuel to produce carbon neutral or carbon negative electricity 103-ELEC to power data center 98 and/or greenhouse 99. The combined cycle gas turbine 10 as configured, can also provide the chilling duty required for the servers, air handling units, or the HVAC systems of data center 98.

Although not shown, the carbon neutral or carbon negative electricity for greenhouse 99 can be produced from a combination of simple cycle, combined cycle, and/or cogeneration turbines and fuel cells.

The low, neutral, and/or negative carbon intensity hydrogen feedstock 101 is sent to gas turbine 11. Hydrogen 101 is mixed with air and/or a diluent, typically consisting of steam, water, or nitrogen, and is combusted in a Brayton cycle to generate carbon neutral or carbon negative electricity 103-ELEC to power data center 98 and/or greenhouse 99. Turbine exhaust 102 is sent to heat recovery steam generator (HRSG) 12, and the cooled turbine exhaust 104 is vented to the atmosphere. Waste heat 116-WH can also be harnessed from turbine exhaust 102, which operates at elevated temperatures, and utilized as a source of thermal energy for heating greenhouse 99.

Superheated steam 106 is produced in HRSG 12 from the waste heat from turbine exhaust 102. Superheated steam 106 is sent to steam turbine 13, in which additional carbon neutral or carbon negative electricity 107-ELEC is produced by a Rankine cycle. Carbon neutral or carbon negative electricity 107-ELEC can be used to power data center 98 and/or greenhouse 99.

HRSG 12 can also be configured to be duct fired with hydrogen 105 and air to produce additional superheated steam and thus generate additional electricity.

Steam 110 is extracted from steam turbine 13 and sent to absorption chiller 15. The heat from the steam is used to drive an evaporation and condensation process that transfers heat from a chilled water system to a cooling water system. Chilled water supply 114 can be used to provide the chilling duty for data center 98 servers either directly, as a liquid cooling medium, or indirectly, as a cooling medium for the immersion circulation fluid. In all embodiments, the chilled water can also be used to provide chilling duty for a variety of commercial and industrial applications, including, but not limited to district cooling, office buildings, and/or warehouses. For illustrative purposes only, the commercial and/or industrial application is represented by data center 98.

Chilled water return 113 is circulated back to absorption chiller 15 to remove heat generated from the data center servers. The chilled water can also be used to provide the chilling duty for the air handling and/or HVAC systems to cool the data center building. Condensed steam 111 from the absorption chiller is sent to deaerator 16.

Steam 115-STM can also be extracted from steam turbine 13 to provide thermal energy for heating greenhouse 99 and/or provide energy to power the mechanical drives for pumps, heat pumps, and/or fans. Steam turbine exhaust 107 is condensed in surface condenser 14, and condensate 109 is sent to deaerator 16.

Deaerator stripping steam 108 is also extracted from steam turbine 13. Boiler feed water 112 from deaerator 16 is sent to HRSG 12 to produce superheated steam 106.

The absorption chiller 15 and surface condenser 14 use cooling water and/or air-cooled heat exchangers to provide a means of cooling to the process. In these applications, the heat generated by the system is rejected to the atmosphere by evaporative cooling towers, air-cooled fans (e.g. dry cooling systems), or a combination thereof. Although not shown in FIG. 1, the cooling water return could be used as a source of thermal energy used for heating greenhouse 99.

Data center 98 requires large cooling loads to reject the heat generated from the servers, air handling units, and/or the heating, ventilation, and air conditioning (HVAC) systems. Waste heat 901-WH from data center 98 information technology (IT) systems and equipment can be converted to thermal energy used for heating greenhouse 99.

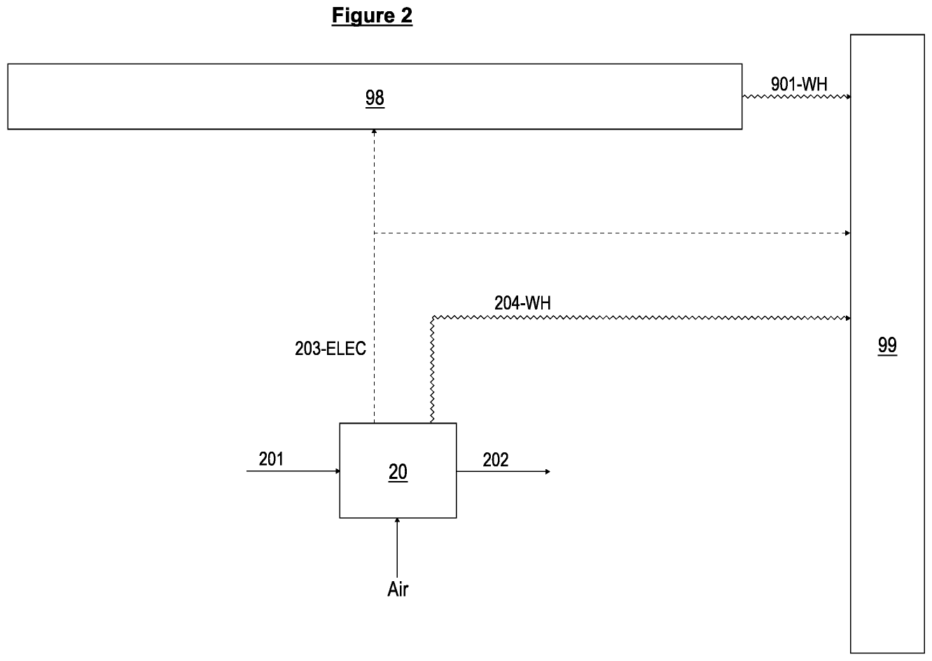

With reference to FIG. 2, a second embodiment of the present invention is depicted, in which waste heat from a fuel cell 20 is used as thermal energy to provide heating for greenhouse 99. The fuel cell 20 utilizes low, neutral and/or negative carbon intensity hydrogen to produce carbon neutral or carbon negative electricity to power data center 98.

The low, neutral, and/or negative carbon intensity hydrogen feedstock 201 is sent to fuel cell 20 where electricity 203-ELEC, generated by an electrochemical process, is used to power data center 98 and/or greenhouse 99. In the electrochemical process, hydrogen 201 is converted into water 202 in the presence of oxygen (air), which acts as an oxidizing agent in the electrochemical process.

Fuel cell 20 also produces a high-grade waste heat 204-WH than can be used as thermal energy to provide heating to greenhouse 99. The high-grade waste heat 204-WH can also be used to heat the steam or water of an absorption chiller to provide the chilling duty required for the servers, air handling units, or the HVAC systems of data center 98, not shown.

As with FIG. 1, waste heat 901-WH from data center 98 information technology (IT) systems and equipment can also be converted to thermal energy used for heating greenhouse 99.

Although not shown, the carbon neutral or carbon negative electricity for greenhouse 99 and/or data center 98 can be produced from a combination of simple cycle, combined cycle, and/or cogeneration turbines and fuel cells.

In yet another embodiment of the present invention, a method for the beneficial use of waste heat in commercial or industrial operations is provided. The method includes generating power by combusting hydrogen in a gas turbine, recovering waste heat from the gas turbine exhaust in a heat recovery steam generator, and utilizing the waste heat in one or more commercial or industrial operations. The gas turbine may be in a simple cycle configuration, a cogeneration configuration, or in a cogeneration configuration. The hydrogen has a carbon intensity preferably less than about 1.0 kg CO₂e/kg H₂, more probably less than about 0.45 kg CO₂e/kg H₂, and most preferably less than about 0.0 kg CO₂e/kg H₂. The hydrogen may be produced by reforming a hydrocarbon feedstock, wherein at least some of the required energy for the reforming process is provided by a biomass power plant with carbon capture. The hydrogen may also be produced by electrolysis of water, wherein at least some of the required energy for the electrolysis process is provided by a biomass power plant with carbon capture. The waste heat may be converted to hot water or steam that can be used as thermal energy in the one or more commercial or industrial operations. At least some of the waste heat may be used as thermal energy in an absorption chiller to provide cooling duty for the one or more commercial or industrial operations. At least some of the waste heat may be converted to steam used to power a mechanical drive for one or more motors generating shaft torque in the commercial or industrial operations. The commercial or industrial operations may include one or more greenhouses, one or more algae farms, and/or one or more data centers. Thermal energy from the waste heat may be used to heat one or more greenhouses, one or more algae farms, and/or one or more data centers. Thermal energy from the waste heat may also be used to cool one or more data centers.

In yet another embodiment of the present invention, a method for the beneficial use of waste heat in commercial or industrial operations is provided. The method includes generating power through an electrochemical process using hydrogen in a fuel cell, recovering waste heat from the fuel cell, and utilizing the waste heat in one or more commercial or industrial operations. The hydrogen has a carbon intensity preferably less than about 1.0 kg CO₂e/kg H₂, more probably less than about 0.45 kg CO₂e/kg H₂, and most preferably less than about 0.0 kg CO₂e/kg H₂. The hydrogen may be produced by reforming a hydrocarbon feedstock, wherein at least some of the required energy for the reforming process is provided by a biomass power plant with carbon capture. The hydrogen may also be produced by electrolysis of water, wherein at least some of the required energy for the electrolysis process is provided by a biomass power plant with carbon capture. The waste heat may be converted to hot water or steam that can be used as thermal energy in the one or more commercial or industrial operations. At least some of the waste heat may be used as thermal energy in an absorption chiller to provide cooling duty for the one or more commercial or industrial operations. At least some of the waste heat may be converted to steam used to power a mechanical drive for one or more motors generating shaft torque in the commercial or industrial operations. The commercial or industrial operations may include one or more greenhouses, one or more algae farms, and/or one or more data centers. Thermal energy from the waste heat may be used to heat one or more greenhouses, one or more algae farms, and/or one or more data centers. Thermal energy from the waste heat may also be used to cool one or more data centers.

In yet another embodiment of the present invention, a method for the beneficial use of waste heat in commercial or industrial operations is provided. The method includes generating a first power by combusting hydrogen in a gas turbine, generating a second power through an electrochemical process using hydrogen in a fuel cell, recovering waste heat from the gas turbine exhaust and from the fuel cell, and utilizing the waste heat in one or more commercial or industrial operations. The hydrogen has a carbon intensity preferably less than about 1.0 kg CO₂e/kg H₂, more probably less than about 0.45 kg CO₂e/kg H₂, and most preferably less than about 0.0 kg CO₂e/kg H₂. The hydrogen may be produced by reforming a hydrocarbon feedstock, wherein at least some of the required energy for the reforming process is provided by a biomass power plant with carbon capture. The hydrogen may also be produced by electrolysis of water, wherein at least some of the required energy for the electrolysis process is provided by a biomass power plant with carbon capture. The waste heat may be converted to hot water or steam that can be used as thermal energy in the one or more commercial or industrial operations. At least some of the waste heat may be used as thermal energy in an absorption chiller to provide cooling duty for the one or more commercial or industrial operations. At least some of the waste heat may be converted to steam used to power a mechanical drive for one or more motors generating shaft torque in the commercial or industrial operations. The commercial or industrial operations may include one or more greenhouses, one or more algae farms, and/or one or more data centers. Thermal energy from the waste heat may be used to heat one or more greenhouses, one or more algae farms, and/or one or more data centers. Thermal energy from the waste heat may also be used to cool one or more data centers.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings therein. It is therefore evident that the particular embodiments disclosed above may be altered or modified and all such variations are considered within the scope and spirit of the present invention.

What is claimed is:

1. A method for the beneficial use of waste heat in commercial or industrial operations, comprising:
generating power by combusting hydrogen in a gas turbine, wherein the hydrogen has a carbon intensity less than about 1.0 kg CO₂e/kg H₂;
recovering waste heat from the gas turbine exhaust in a heat recovery steam generator; and
utilizing the waste heat in one or more commercial or industrial operations.

2. The method of claim 1, wherein the hydrogen is produced by reforming a hydrocarbon feedstock, wherein at least some of the required energy for the reforming process is provided by a biomass power plant with carbon capture.

3. The method of claim 1, wherein the hydrogen is produced by electrolysis of water, wherein at least some of the required energy for the electrolysis process is provided by a biomass power plant with carbon capture.

4. The method of claim 1, wherein the waste heat can be converted to hot water or steam that can be used as thermal energy in the one or more commercial or industrial operations.

5. The method of claim 1, further comprising utilizing at least some of the waste heat as thermal energy in an absorption chiller to provide cooling duty for the one or more commercial or industrial operations.

6. The method of claim 1, wherein at least some of the waste heat is converted to steam used to power a mechanical drive for one or more motors generating shaft torque in the commercial or industrial operations.

7. The method of claim 1, wherein the gas turbine is in a simple cycle configuration.

8. The method of claim 1, wherein the gas turbine is in a combined cycle configuration.

9. The method of claim 1, wherein the gas turbine is in a cogeneration configuration.

10. The method of claim 1, wherein the commercial or industrial operations comprise one or more greenhouses.

11. The method of claim 4, wherein the thermal energy is used to heat one or more greenhouses.

12. The method of claim 1, wherein the commercial or industrial operations comprise one or more algae farms.

13. The method of claim 4, wherein the thermal energy is used to heat one or more algae farms.

14. The method of claim 1, wherein the commercial or industrial operations comprise one or more data centers.

15. The method of claim 4, wherein the thermal energy is used to heat one or more data centers.

16. The method of claim 5, wherein the thermal energy is used to cool one or more data centers.

17. The method of claim 1, wherein the hydrogen has a carbon intensity less than about 0.45 kg CO₂e/kg H₂.

18. The method of claim 1, wherein the hydrogen has a carbon intensity less than about 0.0 kg CO₂e/kg H₂.

19. A method for the beneficial use of waste heat in commercial or industrial operations, comprising:
generating power through an electrochemical process using hydrogen in a fuel cell, wherein the hydrogen has a carbon intensity less than about 1.0 kg CO₂e/kg H₂;
recovering waste heat from the fuel cell; and
utilizing the waste heat in one or more commercial or industrial operations.

20. The method of claim 19, wherein the hydrogen is produced by reforming a hydrocarbon feedstock, wherein at least some of the required energy for the reforming process is provided by a biomass power plant with carbon capture.

21. The method of claim 19, wherein the hydrogen is produced by electrolysis of water, wherein at least some of the required energy for the electrolysis process is provided by a biomass power plant with carbon capture.

22. The method of claim 19, wherein waste heat can be converted to hot water or steam that can be used as thermal energy.

23. The method of claim 19, wherein at least some of the waste heat is used as thermal energy in an absorption chiller to provide cooling duty one or more commercial or industrial operation.

24. The method of claim 19, wherein the commercial or industrial operations comprise one or more greenhouses.

25. The method of claim 22, wherein the thermal energy is used to heat one or more greenhouses.

26. The method of claim 19, wherein the commercial or industrial operations comprise one or more algae farms.

27. The method of claim 22, wherein the thermal energy is used to heat one or more algae farms.

28. The method of claim 19, wherein the commercial or industrial operations comprise one or more data centers.

29. The method of claim 22, wherein the thermal energy is used to heat one or more data centers.

30. The method of claim 23, wherein the thermal energy is used to cool one or more data centers.

31. The method of claim 19, wherein the hydrogen has a carbon intensity less than about 0.45 kg CO₂e/kg H₂.

32. The method of claim 19, wherein the hydrogen has a carbon intensity less than about 0.0 kg CO₂e/kg H₂.

33. A method for the beneficial use of waste heat in commercial or industrial operations, comprising:
generating a first power by combusting hydrogen in a gas turbine;
generating a second power through an electrochemical process using hydrogen in a fuel cell;
recovering waste heat from the gas turbine exhaust and the fuel cell; and
utilizing the waste heat in one or more commercial or industrial operations;
wherein the hydrogen has a carbon intensity less than about 1.0 kg CO₂e/kg H₂.

34. The method of claim 33, wherein the commercial or industrial operations comprise one or more greenhouses.

35. The method of claim 33, wherein the commercial or industrial operations comprise one or more algae farms.

36. The method of claim 33, wherein the commercial or industrial operations comprise one or more data centers.

37. The method of claim 33, wherein the hydrogen has a carbon intensity less than about 0.45 kg CO₂e/kg H₂.

38. The method of claim 33, wherein the hydrogen has a carbon intensity less than about 0.0 kg CO₂e/kg H₂.
